(19) United States
(12) Patent Application Publication
(10) Pub. No.: US 2012/0140502 A1
(43) Pub. Date: Jun. 7, 2012

(54) BEAM PATTERN CHANGING STRUCTURE FOR HEAD LAMP

(75) Inventors: Hyun-Soo Lee, Yongin-si (KR); Byoung Suk Ahn, Suwon-si (KR)

(73) Assignees: Hyundai Mobis, Seoul (KR); Hyundai Motor Company, Seoul (KR)

(21) Appl. No.: 13/208,004

(22) Filed: Aug. 11, 2011

(30) Foreign Application Priority Data
Dec. 3, 2010 (KR) 10-2010-0123068

(51) Int. Cl. F21V 17/02; B60Q 1/04

(52) U.S. Cl. 362/512

(57) ABSTRACT

A beam pattern changing structure for a head lamp is provided, which includes a light source provided in the head lamp to emit light, a reflector provided in the head lamp to reflect the light irradiated through the light source, a shield provided in front of the reflector, and an actuator mounted on the shield to make the shield rotatable. Accordingly, since low beams, high beams, and diverse beam pattern regions in the beam pattern changing stages are all implemented through one light source, the driver's visibility can be maximally secured and the glare of the opposite vehicle can be prevented. Further, the designs of the head lamps for the high beams and the low beams are the same, and thus the merchantability is increased.

### CROSS-REFERENCE TO RELATED APPLICATION

This application is based on and claims priority from Korean Patent Application Number 10-2010-0123068 filed Dec. 3, 2010, the entire contents of which application is incorporated herein for all purposes by this reference.

### BACKGROUND OF INVENTION

1. Field of Invention

The present invention relates to a beam pattern changing structure for a head lamp, and more particularly, to a beam pattern changing structure for a head lamp, which can implement diverse beam patterns using a reflective surface of a rotating shield without lighting of an additional light source.

2. Description of Related Art

In general, as a light source of a vehicle head lamp, a halogen lamp or a gas discharge lamp has been mainly used.

In the case of the halogen lamp, its color temperature is about 3200K, which corresponds to a somewhat red color series, and the maximum lifespan is within 1000 hours to cause a continuous field problem.

By contrast, in the case of the gas discharge lamp, its color temperature is about 4300K, which is close to a white light, and its lifespan is long. Accordingly, in spite of its expensiveness, the gas discharge lamp has been mainly used in a luxury vehicle.

On the other hand, in the case of a white color LED (Light Emitting Diode), its color temperature is about 5500K, which is close to the sunlight. Accordingly, the white color LED greatly lessens eye strain, and thus has recently been watched as a head lamp light source of the vehicle.

Also, in the case of the LED, by minimizing the size thereof, the degree of freedom of the lamp design is heightened, and due to its semi-permanent lifespan, it has the economical efficiency.

Recently, as an AFLS (Adaptive Front Lighting System) is adopted, a driving device is installed inside the lamp. Accordingly, the light emitting direction is varied in accordance with the traveling direction of the vehicle, and thus the driver's visual field becomes clear during the nighttime driving.

However, since all beam patterns except for high beams are prescribed to send light only to the lower part of a horizontal line, visibility cannot be sufficiently secured only with such an ALFS function. Further, using high beams with respect to a forward vehicle may cause the danger of accidents.

In the head lamp as described above, a shield which varies patterns of light that is irradiated in the forward direction of the vehicle through partial limiting of the traveling direction of the light irradiated from the light source may be installed, and diverse variable type beam patterns in the form of high beams, low beams, and intermediate beams between the high beams and low beams may be implemented by the shape of the shield. If such beam patterns are controlled in accordance with the position of the forward vehicle, the driver's visibility can be maximally secured and glare of an opposite vehicle driver can be prevented.

However, since the head lamp for a vehicle in the related art uses a plurality of light sources and a shield that includes a plurality of protrusions having different lengths and shapes in order to implement the light of diverse patterns, the beam pattern change becomes complicated, and the manufacturing cost of the head lamp is increased.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention address the above-mentioned problems occurring in the prior art while advantages achieved by the prior art are maintained intact.

Various aspects of the present invention provide for a beam pattern changing structure for a head lamp, which can implement diverse beam patterns using a reflective surface of a rotating shield without lighting of an additional light source.

Further, during the nighttime driving, using only general low beams cannot secure sufficient visibility distance (although a braking distance of about 90 m is required in the case of driving at a speed of 90 km/h, the performance of the low beams may not reach the distance of about 90 m). By contrast, using the high beams during driving may cause discomfort glare and disability glare of a forward vehicle. In particular, the disability glare due to the high beams of the vehicle is a phenomenon that occurs when excessive light is received in a state where the visual field of an opposite vehicle driver is in a dark adaptation state, and in this case, no image is formed on the retinas of driver's eyes, resulting in that the driver cannot judge the situation in the forward direction.

In order to solve these problems, visibility should be maximally secured without causing the blares to the opposite vehicle driver through variable beam patterns.

Various aspects of the present invention provide for a beam pattern changing structure for a head lamp having a light source provided in the head lamp to emit light, and a reflector provided in the head lamp to reflect the light irradiated through the light source, the beam pattern changing structure including a shield provided in front of the reflector, and an actuator mounted on the shield to make the shield rotatable.

According to the present invention as described above, the effects that can be obtained through rotation are that the light efficiency is increased and the size of an aspheric lens is reduced through the utilization of light leaking out of the lens with an inclined surface of the shield. Further, the beam patterns from the low beams to high beams are successively changed, and in the case of additionally providing logics that match appropriate beam patterns according to the position of the forward vehicle, both the increase of visibility and the prevention of glare, which are biggest problems in the beam patterns of the head lamps, can be secured.

Further, since beam pattern regions of high beams and low beams are all implemented through one light source, the design of the head lamp during the lighting is improved and thus the merchantability is increased.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is view illustrating a state of a shield before its rotation (low beams) in an exemplary beam pattern changing structure according to the present invention.

FIG. 2 is view illustrating a state of a shield after its rotation (high beams) in an exemplary beam pattern changing structure according to the present invention.

FIGS. 3A and 3B are views illustrating an exemplary beam pattern changing structure for a head lamp according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

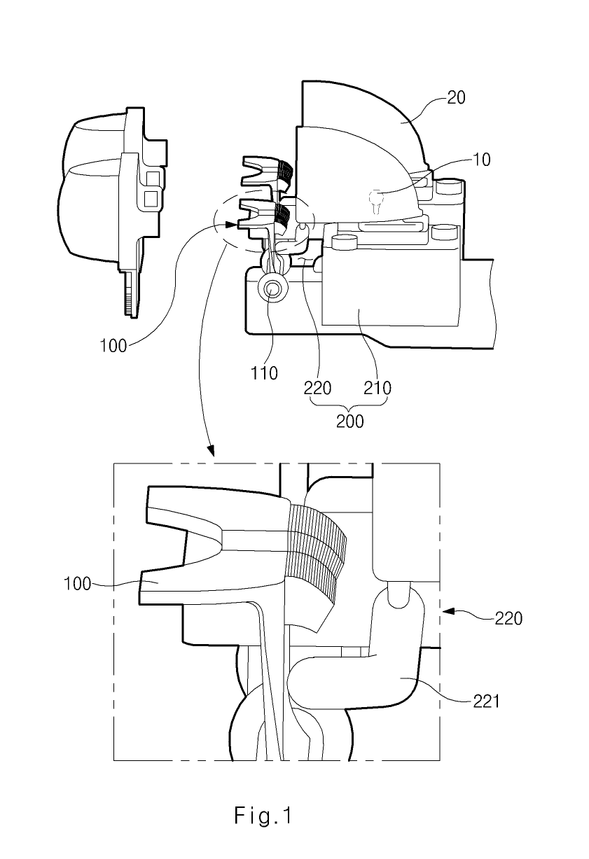

FIGS. 1 to 3 illustrate a beam pattern changing structure according to various embodiments of the present invention. A beam pattern changing structure for a head lamp according to various embodiments of the present invention, as illustrated in FIGS. 1 to 3, includes a reflector 20 provided inside the head lamp to reflect light that is irradiated through a light source 10, a shield 100 provided in front of the reflector 20 to change the direction of the light, and an actuator 200 making the shield 100 rotatable, wherein beam pattern regions of high beams and low beams are all implemented through the light source 10 and the rotatable shield 100.

Hereinafter, respective constituent elements of the beam pattern changing structure for a head lamp according to various embodiments of the present invention will be described with reference to the accompanying drawings.

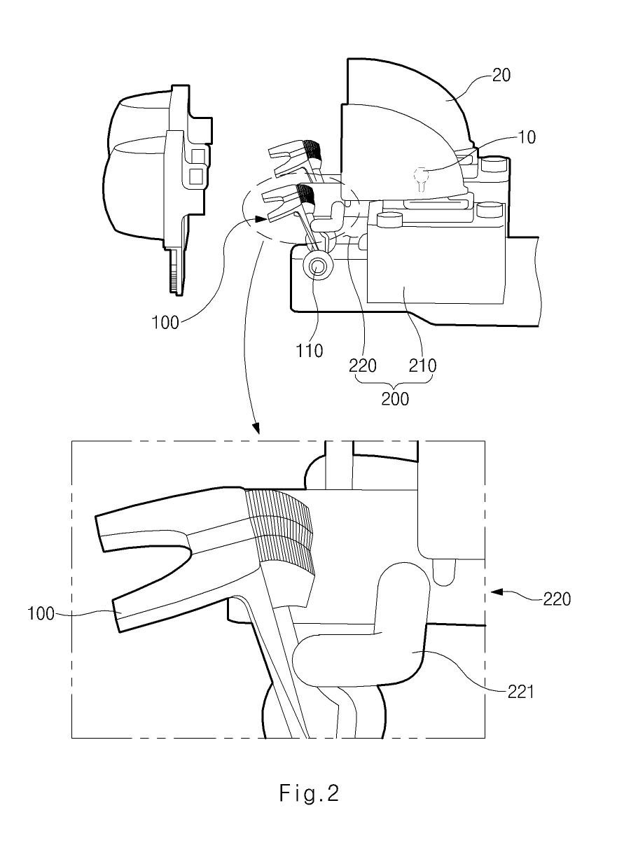

As illustrated in FIGS. 1 and 2, the shield 100 is provided in front of the reflector 20 and changes the direction of light emitted from the light source 10.

The shield 100 is rotatable by the actuator 200 to be described later.

The actuator 200 is mounted on the shield 100, and makes the shield 100 rotatable within a predetermined angle range.

Here, the actuator 200 includes a motorized portion 210 provided in the lower portion of the shield 100 to rotate, and a gear stick 220 having one side connected to the motorized portion 210 to convert a rotation motion into a linear motion and the other side connected to the shield 100 to push the shield 100 through the linear motion in the forward and backward directions.

On the other hand, the center shaft 110 may be provided at a lower end of the shield 100 to make the shield 100 rotate about the center shaft 110 when the gear stick 220 is operated.

Also, a protrusion portion 221 is formed on one side surface of the gear stick 220. The protrusion 221 may be positioned on the side of the shield 100 to rotate the shield 100 when the gear stick 220 is moved by the operation of the motorized portion 210.

In this case, the shield 100 may be “ [symbol] ”-shaped, and is rotated by the actuator 200. During the beam pattern change, the shield 100 intercepts the light emitted from the light source 10, and reflects the intercepted light through an upper end portion of the shield 100 to enable the reflected light to be incident to the aspheric lens.

On the other hand, the motorized portion 210 may be bidirectionally rotatable to restore the shield 100 that is rotated to change the beam patterns to its initial position.

Hereinafter, the operation and effect of the beam pattern changing structure for a head lamp according to various embodiments of the present invention will be described.

As illustrated in FIGS. 1 and 2, the reflector 20 is provided inside the head lamp to reflect the light that is irradiated through the light source 10, and the shield 100 is provided in front of the reflector 20 to change the direction of the light. The actuator 200 is mounted to make the shield 100 rotatable, and when the shield 100 is rotated, the direction of the light emitted from the light source 10 is changed, and thus the beam pattern regions of high beams and low beams are all implemented.

In this case, the actuator 200 is composed of the motorized portion 210 and the gear stick 220. When the motorized portion 210 is operated, the gear stick 220 is moved in the forward and backward directions, and the shield 100 is rotated by the movement of the gear stick 220.

Here, when the shield 100 is rotated by the actuator 200, the light emitted from the light source 10 is transferred in various directions through the upper end portion of the shield 100 to change the beam patterns.

As described above, according to the present invention, the high beams and the low beams are implemented, and when the light change is implemented from the high beams to the low beams and vice versa, the light efficiency can be improved by controlling the rotation angle of the shield 100.

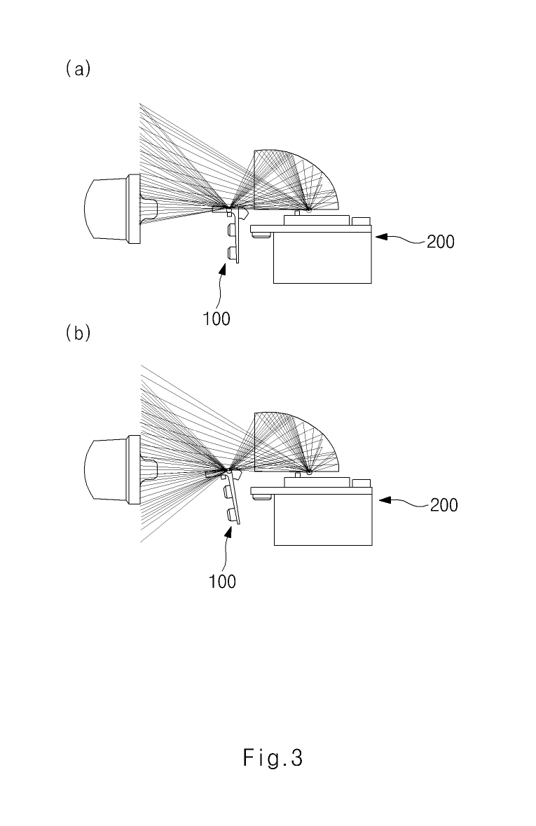

Also, as illustrated in FIGS. 3A and 3B, when the high beams and the low beams are implemented through the rotation of the shield 100, the light passes through a portion that is below the focus, and the light exists above the cutoff line to widen the viewing angle. Also, the light that leaks out of the lens is incident to the inside due to the total reflection of the shield 100, and thus more beams can be used to improve the light efficiency.

As described above, the beam pattern changing structure for a head lamp according to the present invention includes the light source provided in the head lamp to emit light, the reflector provided in the head lamp to reflect the light irradiated through the light source, the shield provided in front of the reflector, and the actuator mounted on the shield to make the shield rotatable. Accordingly, since the beam pattern regions of the high beams and the low beams are all implemented through one light source, the design of the head lamp during the lighting is improved and thus the merchantability is increased.

For convenience in explanation and accurate definition in the appended claims, the terms upper or lower, front, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A beam pattern changing structure for a head lamp comprising:
a light source provided in the head lamp to emit light;
a reflector provided in the head lamp to reflect the light irradiated through the light source;
a shield provided in front of the reflector; and
an actuator mounted on the shield for rotating the shield.

2. The beam pattern changing structure for a head lamp according to claim 1, wherein the actuator comprises:
a motorized portion provided in a lower portion of the shield; and
a gear stick having one side connected to the motorized portion and the other side connected to the shield.

3. The beam pattern changing structure for a head lamp according to claim 2, wherein a center shaft is provide at a lower end of the shield.

4. The beam pattern changing structure for a head lamp according to claim 2, further comprising a protrusion portion on one side surface of the gear stick, which is positioned on a side of the shield to rotate the shield when the gear stick is moved by the operation of the motorized portion.

5. The beam pattern changing structure for a head lamp according to claim 1, wherein the shield 100 is “ [symbol] ”-shaped to change the beam patterns through an upper end portion of the shield.
